(19) United States
(12) Patent Application Publication
(10) Pub. No.: US 2017/0203882 A1
(43) Pub. Date: Jul. 20, 2017

(54) DEVICE FOR CLOSING POUCHES WITH TACTILE AND SOUND FEATURES AND POUCH COMPRISING SUCH A DEVICE

(71) Applicant: S2F FLEXICO, Henonville (FR)

(72) Inventors: Henri Bois, Neuilly-sur-Seine (FR); Isabelle Moulin, Paris (FR)

(21) Appl. No.: 15/479,064

(22) Filed: Apr. 4, 2017

Related U.S. Application Data
(62) Division of application No. 14/359,562, filed on Oct. 7, 2014.

(30) Foreign Application Priority Data
Nov. 21, 2011 (FR) 1160605

(51) Int. Cl. B65D 33/25; B29D 5/10

(52) U.S. Cl. CPC B65D 33/255; B65D 33/2558; B29D 5/10; B29K 2023/065

(57) ABSTRACT

The present invention relates to a device for closing pouches or the like comprising a series of complementary parallel profiles (110a-110e, 210a-210e), said profiles being carried by respective supporting sheets (100, 200), characterised in that said device has sequential alterations (300) in at least one profile (110, 210) along a direction perpendicular to the supporting sheets (100, 200).

The present invention relates to the field of closure devices for bags, sacks or the like.

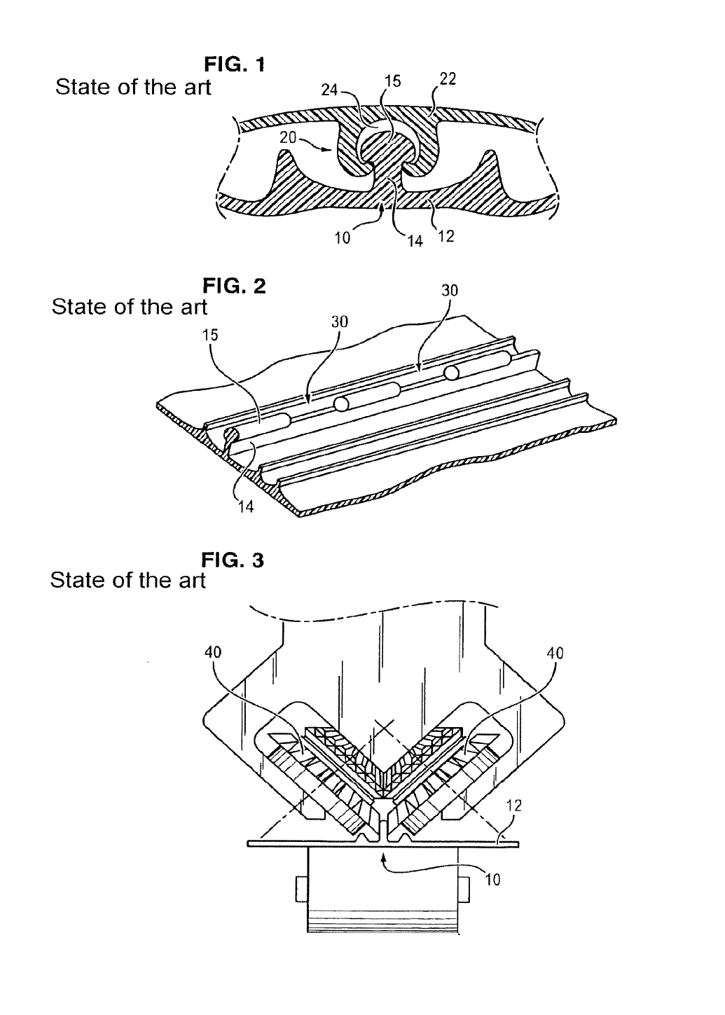

More specifically, the present invention relates to closure devices based on two complementary profiles 10, 20, borne by respective opposite support webs or walls 12, 22 as illustrated as a non-limiting example in the appended FIG. 1.

Many alternative embodiments of the device illustrated in FIG. 1 have already been proposed and fall within the scope of the present invention.

Generally, the aforementioned complementary profiles are formed with the complementary male/female elements, the male element comprising a rod 14 secured to the web or to the wall 12 and provided with a widened protrusion 15 at its top, while the female element 20 is formed with a groove 24 with convergent edges having as a section, a complementary cavity of the protrusion 15.

The general purpose of the present invention is to propose enhancements to the thereby known profiles in order to generate a tactile sensation and a sound effect upon closing or opening the aforementioned device, i.e. upon engaging the profiles 10, 20 and separating the latter.

Various arrangements have already been proposed in order to generate such tactile sensations and sound effects upon closing and opening the aforementioned device.

Examples of such known arrangements are described in documents WO 96/28063, U.S. Pat. No. 5,070,584 and EP 0 446 760. These documents disclose means as illustrated in the appended FIGS. 2 and 3. As seen in FIG. 2, the known arrangements most often consists of performing sequential deformation or cutting 30 along one of the two profiles, for example the male profile 10 according to the illustration of FIG. 2, in order to thereby define a succession of hard points and of weak points in the respective engagement of the elements 10, 20.

As illustrated in FIG. 3, the known means for making such closing devices according to the prior art, generally proceed with squeezing or lateral cutting of one of the profiles, for example the male profile 10, by means of notched knurls 40 driven into rotation around a general axis transverse to the support webs or walls 12 of the relevant profile, i.e. along a thickness deformation or modification direction parallel to the support webs or walls 12.

In this context, the particular aim of the present invention is to improve the known arrangements of the prior art to reinforce the tactile sensation and the sound effect.

Another object of the invention is to propose a closure device which is tightly sealed.

This object is attained within the scope of the present invention by a closure device for bags or the like including a series of parallel complementary profiles borne by support webs, characterised in that it has sequential alterations of at least one complementary profile, in a direction perpendicular to the support webs.

Some preferred though non-limiting aspects of the closure device according to the invention are the following:
sequential alterations include sequential crushings in contact, such that sequential crushings effect flaring of both complementary profiles in the direction of the width transversal to the elongation direction of the closure device,
sequential alterations include sequential incisions without removal of material,
the device includes at least five complementary profiles, whereof at least three complementary profiles including sequential crushings and at least one complementary profile including sequential incisions,
the device includes at least five complementary profiles, whereof at least three complementary profiles include sequential alterations and at least one complementary profile is devoid of sequential alterations,
the complementary profiles include profiles of male/male type,
at least one part of the complementary profiles is made of a first material, and at least one other part of the complementary profiles is made of a second material, different to the first material,
the first material includes polypropylene or polyethylene high-density, and the second material includes polyethylene or polyethylene low-density,
the complementary profiles including sequential alterations are made of the first material,
the device includes both complementary profiles including sequential alterations and complementary profiles devoid of sequential alterations, and wherein the complementary profiles devoid of sequential alterations are made of the second material,
the complementary profiles made of the first material and/or the complementary profiles made of the second material are formed integrally with a tread, attached on the corresponding web,
the tread is attached on the corresponding web by means of a binder,
the tread is embedded in the corresponding web such that said tread is attached on said web, and
the pitch of the sequential crushings is comprised between 4 mm and 1 cm.

According to a second aspect, the invention also proposes a bag including a device such as described hereinabove.

Other characteristics, objects and advantages of the present invention will emerge from the following detailed description, and with respect to the appended diagrams given by way of non-limiting examples and wherein:

FIGS. 1, 2 and 3 described earlier respectively illustrate a transverse sectional view of a closure device according to the state of the art which may be used within the scope of the present invention, a partial perspective view of a closure device having sequential cutouts compliant with the state of the art and a tool according to the state of the art including two lateral squeezing knurls over a closure profile, movable along an axis of rotation globally transverse to the support webs of said profile,

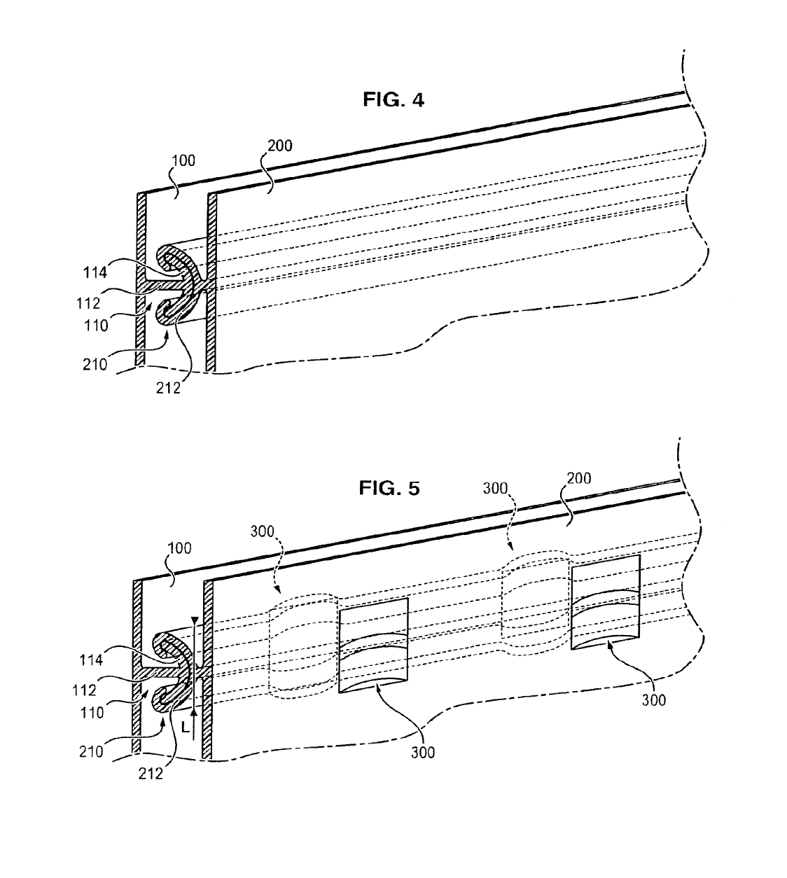

FIG. 4 illustrates a schematic view in partial perspective of a closure device before alteration according to the present invention,

FIG. 5 illustrates the same closure device in partial perspective after sequential alteration according to the present invention, wherein the sequential alterations are crushings,

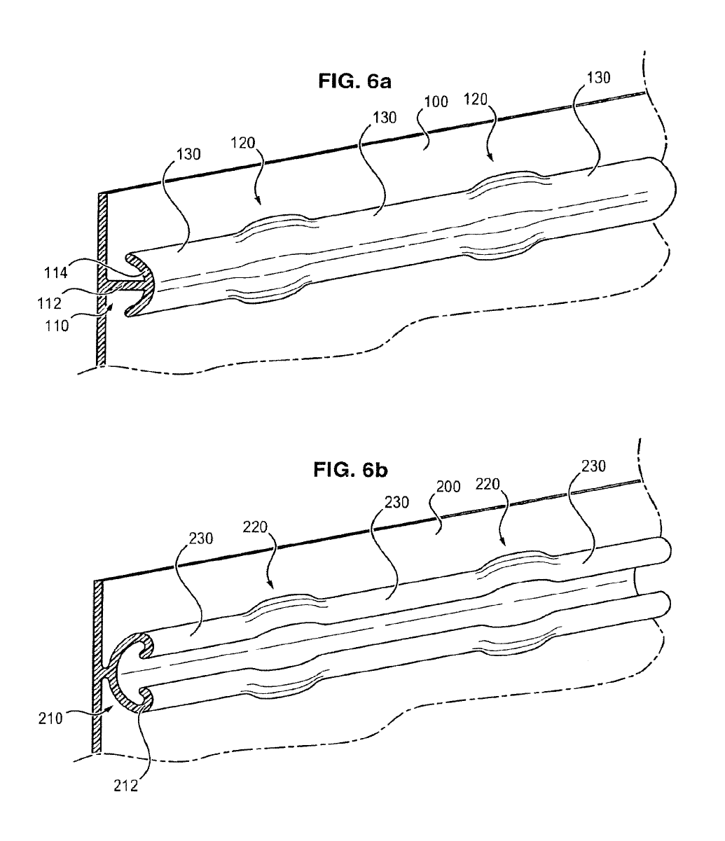

FIGS. 6a and 6b respectively illustrate individual views of a first embodiment of a male profile and a female profile in combination forming a closure device according to the present invention illustrated in FIG. 5,

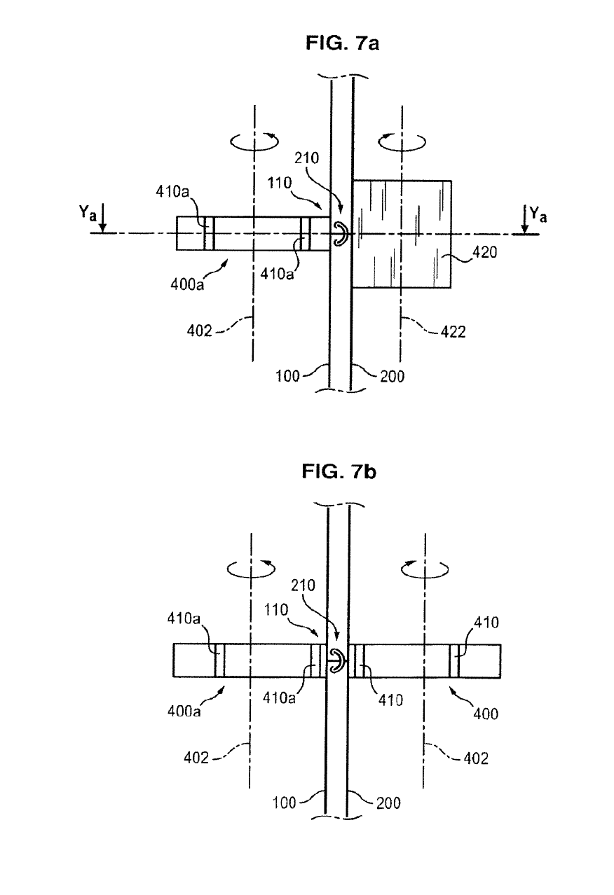

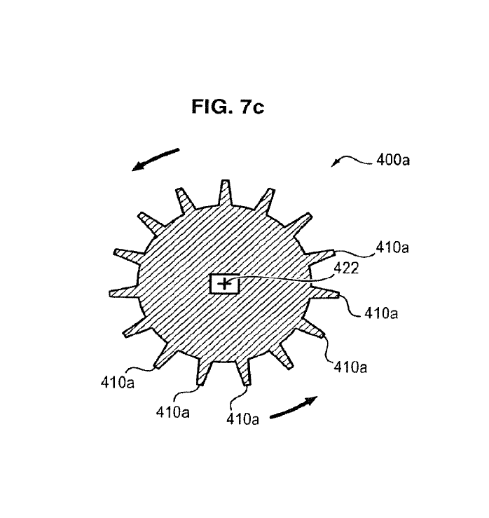

FIG. 7a illustrates a view in transversal segment of a closure device during squeezing according to the present invention and an example of a tool used for this purpose,

FIG. 7b illustrates an alternative of a view in transversal segment of a closure device during squeezing according to the present invention and an alternative of a tool used for this purpose,

FIG. 7c is a view in segment according to the axis Ya-Ya of FIG. 7a of an embodiment of a knurl which can be used in the tools illustrated schematically in FIGS. 7a and 7b,

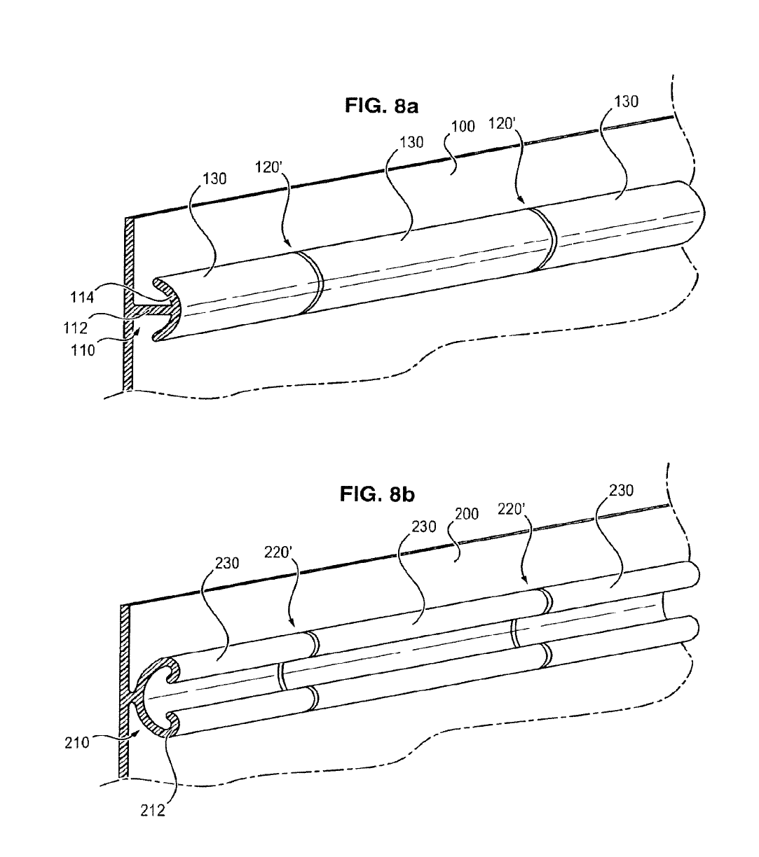

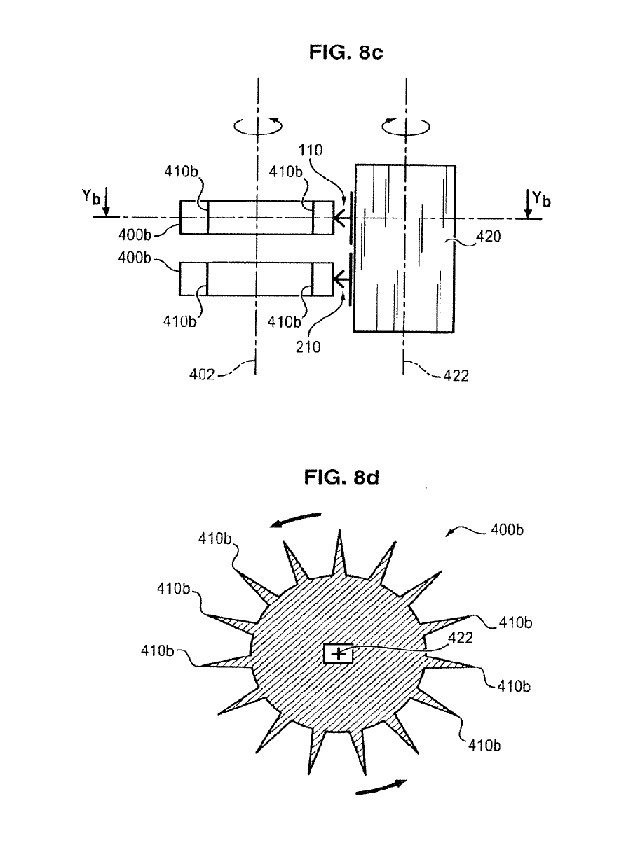

FIGS. 8a and 8b respectively illustrate individual views of a second embodiment of a male profile and a female profile forming in combination a closure device according to the present invention, wherein the sequential alterations are incisions without removal of material,

FIG. 8c illustrates a view in transversal segment of a complementary profile of a closure device during alteration by incision according to the present invention and an example of a tool used for this purpose,

FIG. 8d is a view in segment according to the axis Yb-Yb of FIG. 8c of an embodiment of a knurl which can be used in the tool illustrated schematically in FIG. 8c,

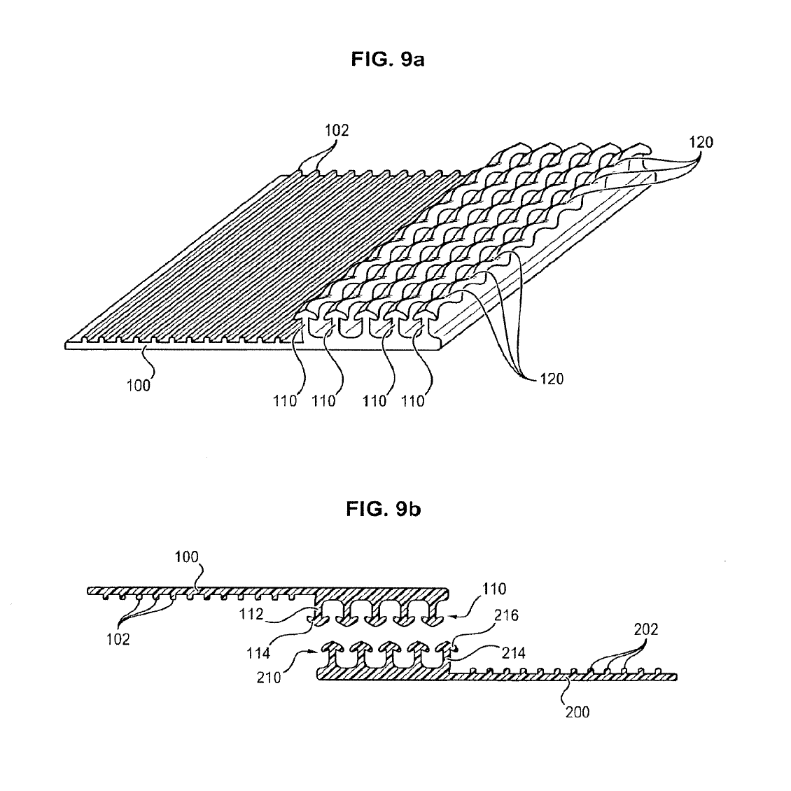

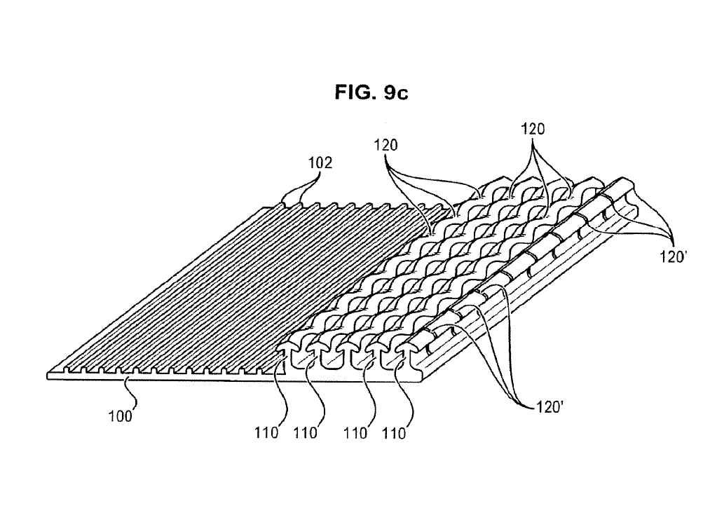

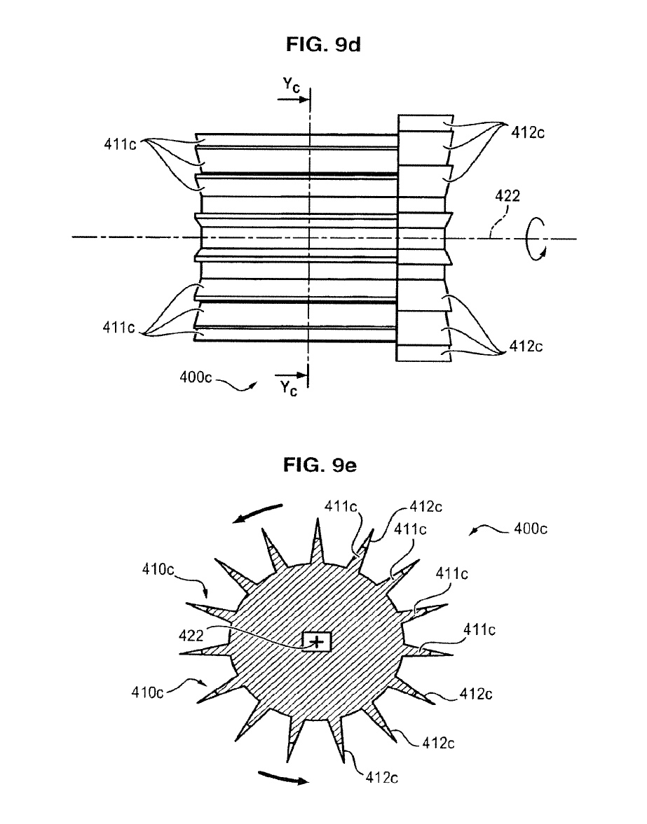

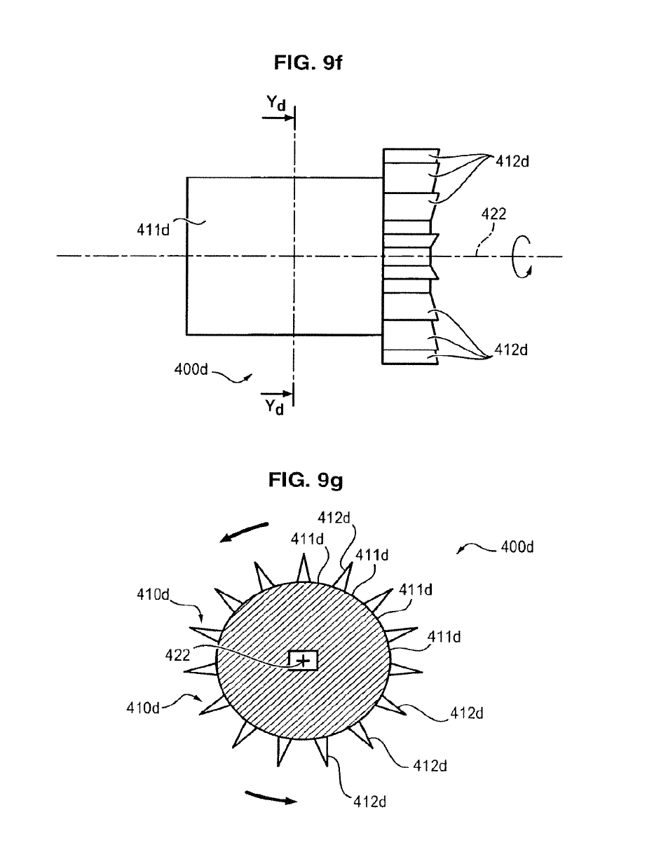

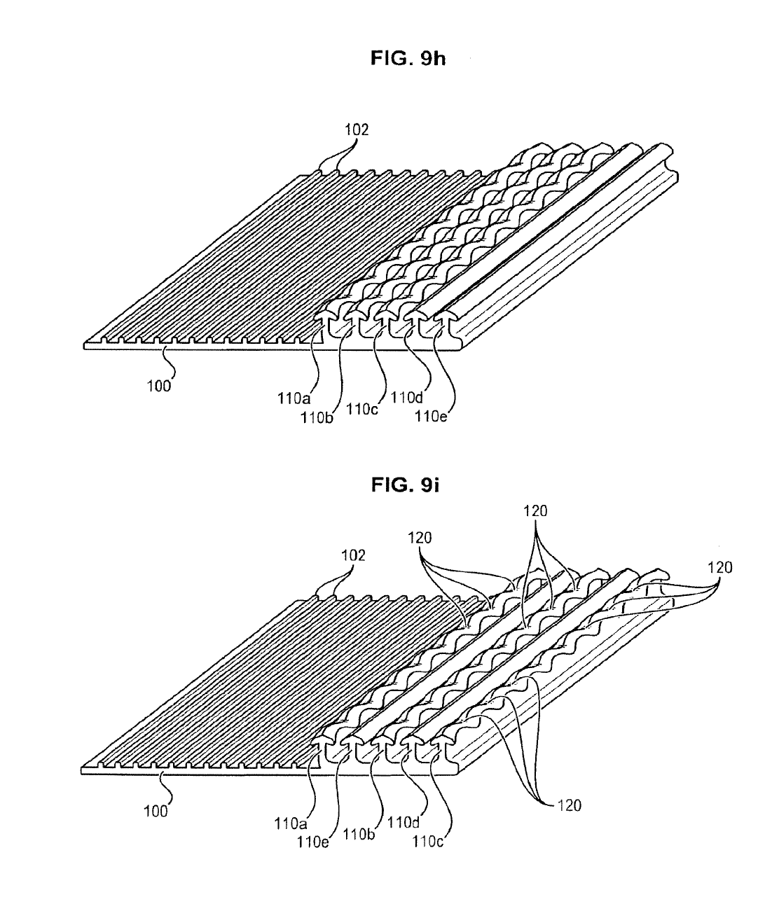

FIGS. 9a, 9c, 9h and 9i illustrate views in perspective of embodiments of support webs which can be used in a closure device according to the invention,

FIG. 9b is a view in transversal segment of an embodiment of a closure device according to the invention, prior to contacting of the complementary profiles,

FIG. 9d is a view side of an embodiment of a knurl which can be used in the tool illustrated schematically in FIG. 8c,

FIG. 9e is a view in segment according to the axis Yc-Yc of the knurl of FIG. 9d,

FIG. 9f is a side view of an embodiment of a knurl which can be used in the tools illustrated schematically in FIGS. 7a, 7b and 8c,

FIG. 9g is a view in segment according to the axis Yd-Yd of the knurl of FIG. 9f,

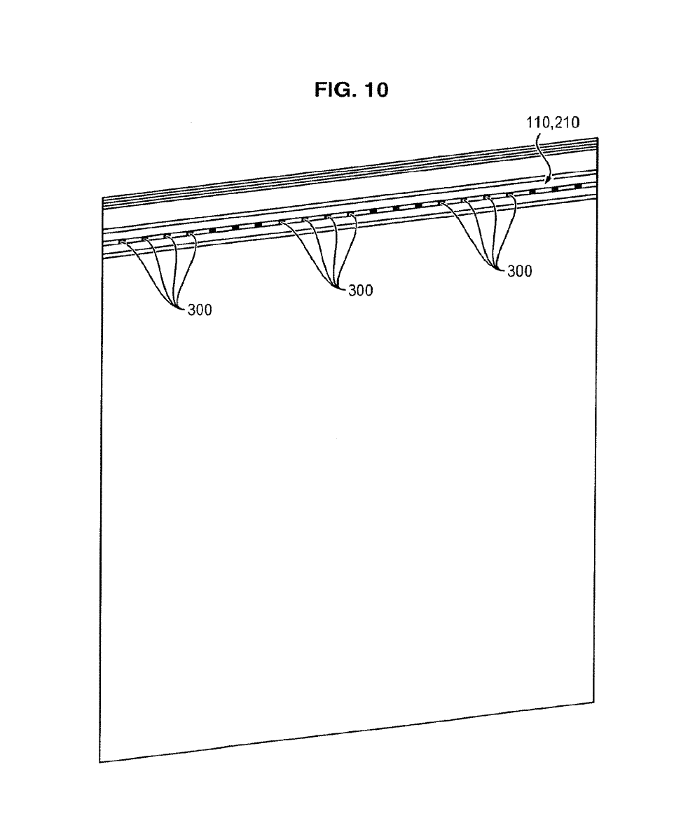

FIG. 10 illustrates a view in perspective of a bag according to the present invention including sequential alterations made according to the modalities of the invention,

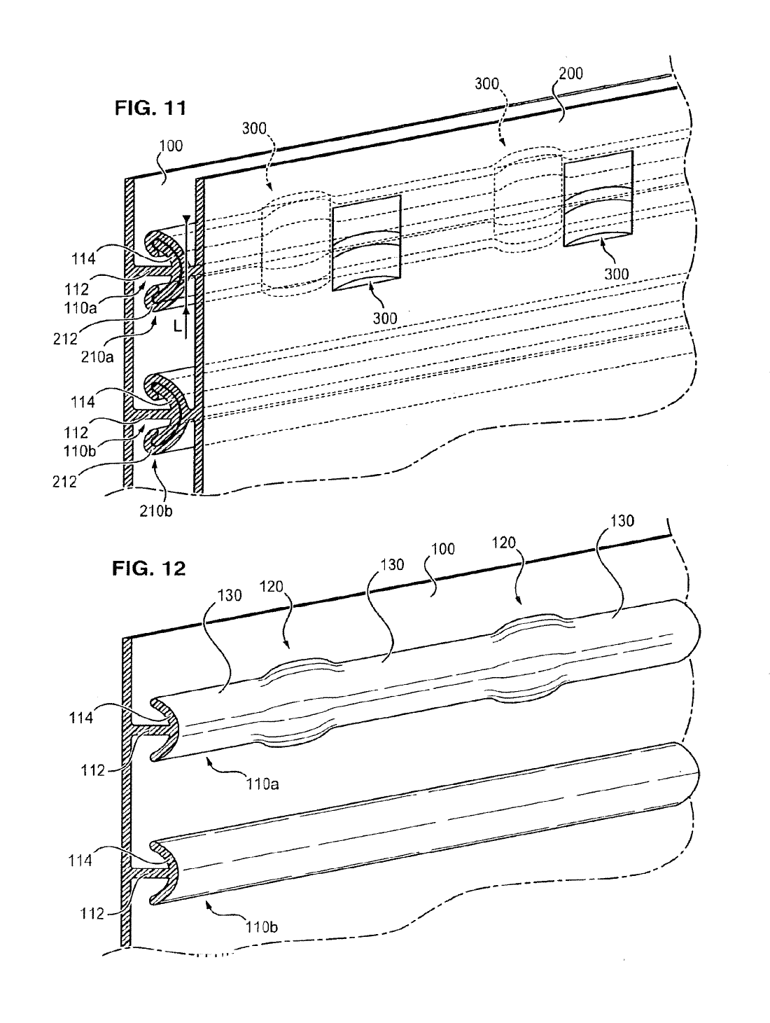

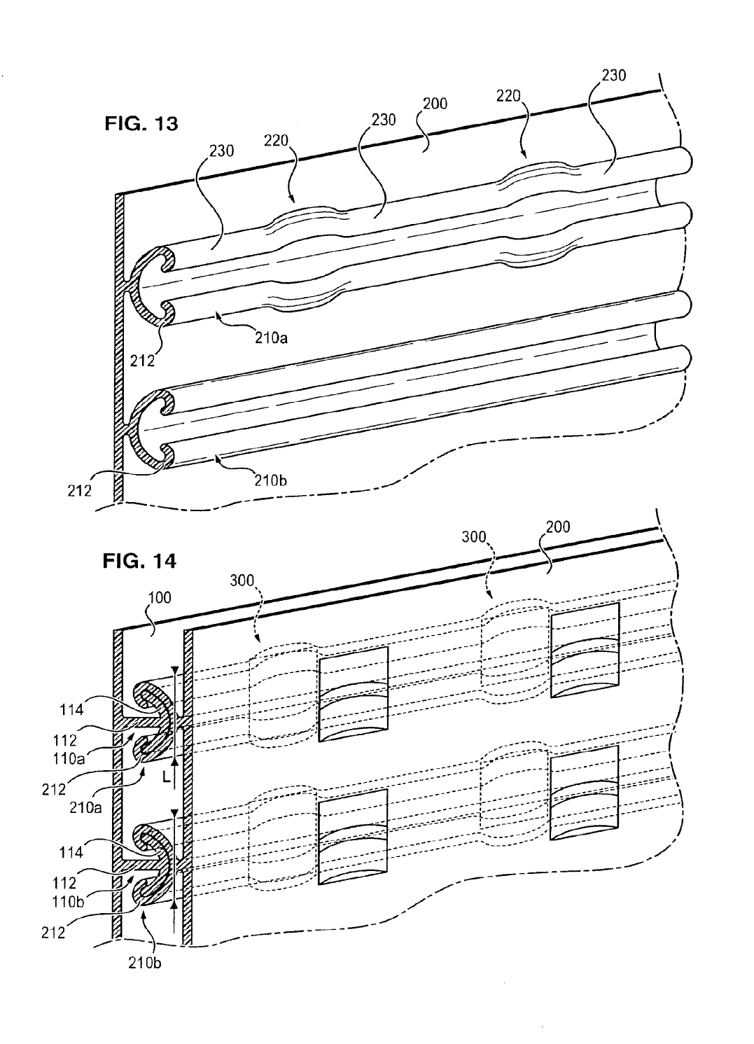

FIGS. 11, 12 and 13 illustrate respectively, for a first alternative embodiment of a closure device according to the present invention including two pairs of parallel complementary closing profiles, a view in partial perspective of the closure device after sequential squeezing of a pair of profiles and individual views of male profiles and female profiles forming in combination a closure device according to the present invention illustrated in FIG. 11,

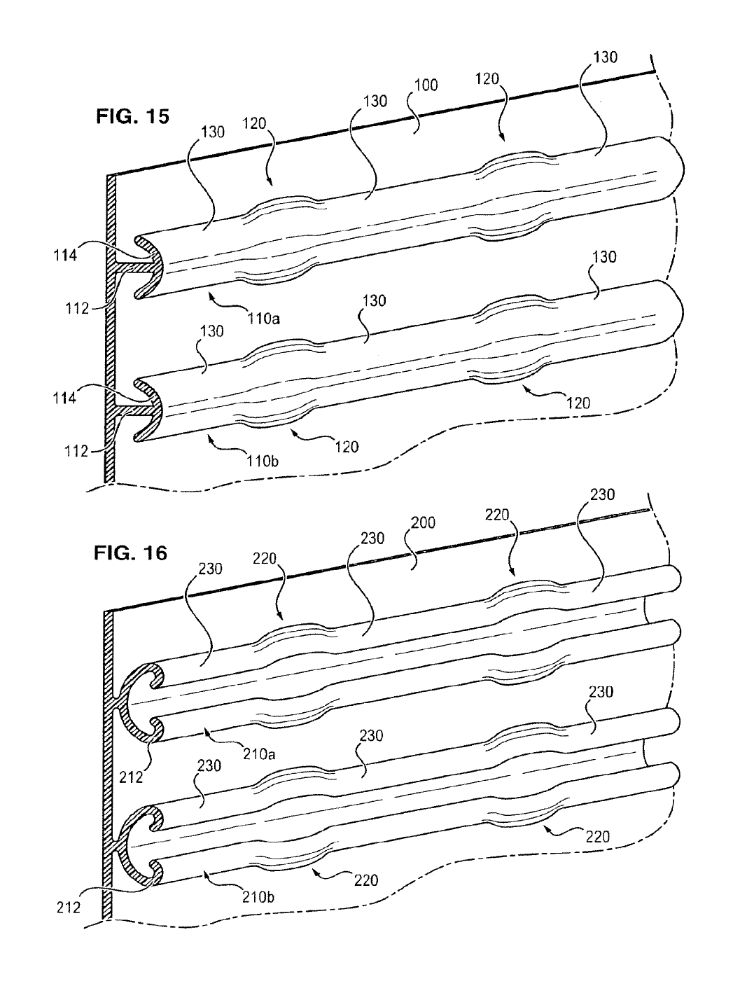

FIGS. 14, 15 and 16 respectively illustrate, for a second alternative embodiment of a closure device according to the present invention including two pairs of parallel complementary closing profiles, a view in partial perspective of the closure device after sequential squeezing of two pairs of profiles and individual views of male profiles and female profiles forming in combination a closure device according to the present invention illustrated in FIG. 14,

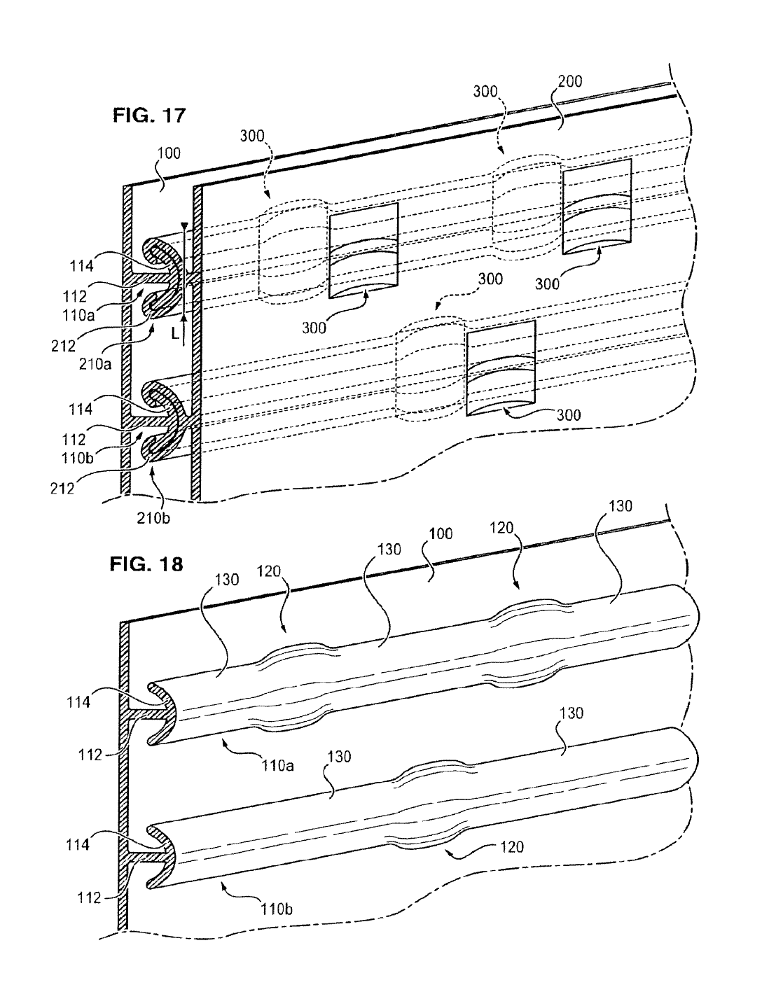

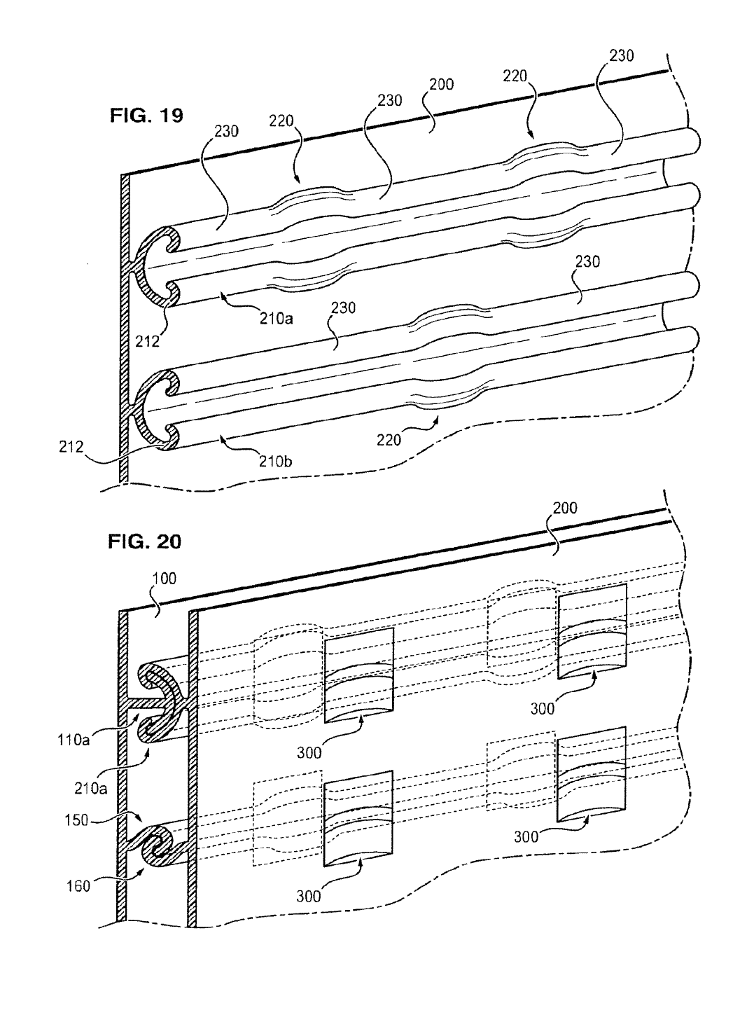

FIGS. 17, 18 and 19 illustrate respectively, for a third alternative embodiment of a closure device according to the present invention including two pairs of parallel complementary closing profiles, a view in partial perspective of the closure device after sequential squeezing of both pairs of profiles with longitudinal shift between the crushings made on both pairs of profiles and individual views of male profiles and female profiles forming in combination a closure device according to the present invention illustrated in FIG. 17,

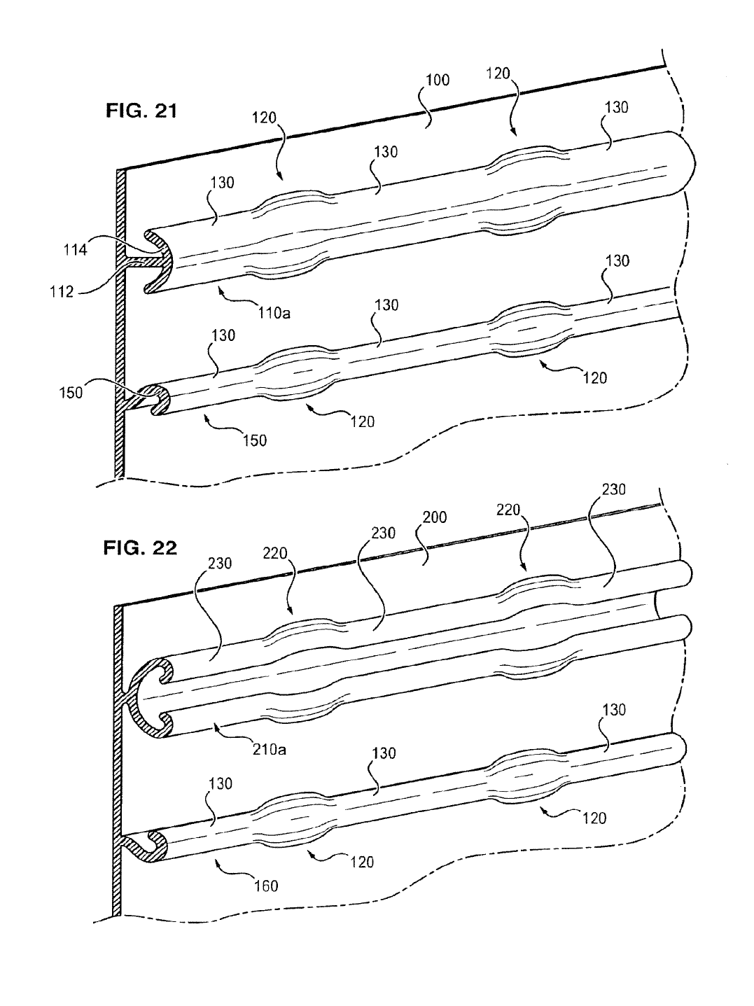

FIGS. 20, 21 and 22 respectively illustrate, for a fourth alternative embodiment of a closure device according to the present invention including two pairs of parallel complementary closing profiles, one of complementary male/female type and the other of complementary hook type, a view in partial perspective of the closure device after sequential squeezing and individual views of the profiles borne by supporting films opposite and in combination forming a closure device according to the present invention illustrated in FIG. 20, and

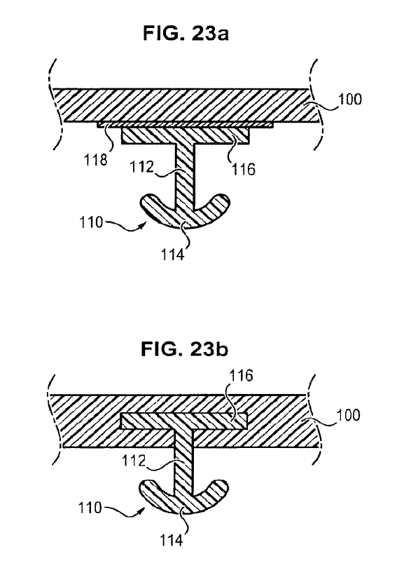

FIGS. 23a and 23b schematically illustrate a complementary profile attached by means of an embodiment of a tread on a corresponding support web.

The appended FIG. 4 illustrates a closure device including two support webs 100, 200 respectively carrying two complementary profiles 110, 210.

According to the particular embodiment illustrated in FIG. 4, the first profile 110 includes a rod 112 overall perpendicular to the support web 100 and fitted at its top opposite the support web 100 with a widened protrusion 114. The complementary female profile 210 per se essentially includes a groove with converging edges 212 defining in its segment a complementary cavity of the widened protrusion 114.

The complementary closing profiles 110 and 210 present a constant segment over their length. They are preferably made by extrusion. Such a closure device will not be described in more detail in its initial structure, to the extent where such closure devices are well known to one skilled in the art, and can give rise to many embodiments or alternatives. One example is an alternative embodiment wherein the closure device includes two complementary profiles 110, 210, not in the form of a male element or complementary a female element, but in the form of simple complementary hooks or complementary male profiles.

Also, within the scope of the present invention, there can be either a closure device including both closing profiles 110, 210 made separately from a bag, then connected and attached for example by thermal welding onto films including a bag or even a closure device directly forming a single piece, for example extrusion, with films forming the walls of the bag.

As indicated previously, within the scope of the present invention the complementary profiles 110, 210 are altered sequentially according to alteration in a direction perpendicular to the webs and supporting walls 100, 200. The sequential alterations are sequential local modifications of the profiles 110, 210, which can especially include sequential crushings and/or sequential incisions without removal of material. FIG. 5 illustrates the alteration areas resulting at the level of an area referenced 300. The alteration areas 300 cover all or part of the width L of the relevant profiles perpendicularly to their elongation direction.

According to a first embodiment, FIGS. 6a and 6b respectively illustrate a male profile 110 and a female profile 210 altered sequentially by squeezing. FIGS. 6a and 6b illustrate sequential flarings 120, 220 according to the width transversal to the elongation direction, both of the male profile 110 and of the female profile 210. However, as the sequential squeezing is borne out according to the present invention when both profiles 110, 210 are in the assembled position, this ensures that the transversal segments, both the male profile 110 and the female profile 210, although deformed by flaring, remained properly paired, complementary to a certain degree, and compatible both for closing, that is, placing in contact, and opening, that is, separation.

As illustrated in FIGS. 7a and 7c, the sequential crushings can be achieved within the scope of the present invention by means of a notched knurl 400a with peripheral protrusions 410a at the preferred pitch of the sequential crushings 300, urging one side of the closure device and a simple support roller 420 located on the opposite side.

The knurl 400a and the support roller 420 illustrated in the Figs. are driven in rotation according to axes 402, 422 parallel to each other and parallel to the main direction of the complementary profiles 110, 210.

The appended FIG. 7b illustrates an alternative embodiment according to which sequential squeezing according to the present invention is achieved by means of two rollers or notched knurls 400a arranged respectively on either side of the closure device, the toothed rollers 400a including protrusions 410a at the pitch of the preferred crushings 300 and here too being driven in rotation about axes 402 parallel to each other and parallel to the principal direction of the complementary profiles 110, 210. Both knurls 400a are synchronised such that their respective protrusions simultaneously stress the profiles 110, 210 by squeezing.

According to a first embodiment, FIGS. 8a and 8b respectively illustrate a male profile 110 and a female profile 210 altered sequentially by incision without removal of material. The Figs. actually show sequential incisions 120′, 220′ according to the width transversal to the elongation direction, both of the male profile 110 and the female profile 210. It is evident that the incisions 120′, 220′ of the profiles 110 and profiles 210 are preferably arranged opposite when the profiles are assembled to form the closure device. This is not however limiting, to the extent where the incisions 120′, 220′ could be shift to each other relative to the others on the profiles 110 and 210 without any impact on the sound and tactile effects of the closure device.

The sequential incisions 120′, 220′ are made preferably in a separate position of both profiles 110, 210. It has actually been noted that in the event where the alterations include incisions, it is not necessary for the incisions 120′, 220′ of the profiles 110, 120 to be opposite so that the profiles remain perfectly paired and complementary, such that they remain compatible both for closing and opening. In addition, the sequential incisions 120′, 220′ are preferably achieved so as to not cut the support web 100, 200 carrying the complementary profiles 110, 210. It is therefore preferable to make the incisions 120′, 220′ directly on the profiles 110, 210 rather than indirectly by applying stress to the webs 100, 200.

As illustrated in FIGS. 8c and 8d, the sequential incisions 120′, 220′ can be made by means of a tool including a notched knurl 400b with peripheral protrusions 410b at the preferred pitch of the sequential incisions 120′, 220′, cutting the profiles 110, 210 of the closure device according to their width, and a simple support roller 420 located on the opposite side.

The knurl 400b and the support roller 420, are driven in rotation according to the axes 402, 422. also, the sequential incisions 120′, 220′ of both complementary profiles 110, 210 can be made either simultaneously on the same support roller 420 (or optionally on two separate support rollers), by means of two knurls 400b, as illustrated in FIG. 8c, or successively by means of two sets of knurls 400b and corresponding support rollers 420.

According to an embodiment, the support webs 100, 200 of the closure device can each carry at least two complementary profiles 110a-110e, 210a-210e for multiple closing. The sequential alterations 300 can include sequential crushings 120, 220 and/or sequential incisions 120′, 220′ (that is either only sequential crushings 120, 220, or only sequential incisions 120′, 220′, or both sequential crushings 120, 220 and sequential incisions 120′, 220′).

FIGS. 9a to 9c, 9h and 9i for example illustrate webs 100, 200 each including five complementary profiles 110a-110e, 210a-210e. The profiles 110a-110e, 210a-210e are all male/male profiles, each including a rod 112, 214 overall perpendicular to the support web 100, 200 and fitted with a widened protrusion 114, 216 at its top opposite the support web 100, 200 in the form of an arrow head. This is not however limiting, to the extent where the webs can include a different number of complementary profiles 110, 120, in particular three, four, or six, which can be of male/male, male/female type, hooks, or any other conventional form in the field of closing profiles.

The complementary profiles 110a-110e, 210a-210e of FIG. 9a include only sequential crushings. In this embodiment, the width of the knurl 400a and its peripheral protrusions 410a is dimensioned so as to simultaneously squeeze the set of profiles 110, 120 of the webs 100, 200, the webs being preferably in the assembled position to guarantee their later pairing.

It is understood of course that the complementary profiles can similarly include sequential incisions 120′, 220′ only. The width of the knurl and its peripheral protrusions are dimensioned so as to simultaneously cut the set of profiles 110, 120 of the webs 100, 200, the webs being preferably in a separate position for easier cutting. And preferably, the height and the point of the free end of the peripheral protrusions is dimensioned to cut the complementary profiles 110, 120 only, without altering the corresponding support web 100, 200.

The appended FIG. 9c illustrates an alternative embodiment wherein the sequential alterations include both sequential crushings 120, 220 and sequential incisions 120′, 220′.

The sequential alterations 300 can be made whereas the complementary profiles are separate by means of a tool including a notched knurl 400c with peripheral protrusions 410c at the preferred pitch of the sequential crushings 120, 220 and sequential incisions 120′, 220′, and a simple support roller 420 situated on the opposite side. As is evident in FIGS. 9d and 9e, the peripheral protrusions 410c of the knurl 400c present as such a first part 411c, adapted to perform the sequential crushings 120, 220 by locally flaring profiles 110, 210, and a second part 412c, extending in the extension of the first part 411c, adapted to cut the profiles 110, 210 according to their width, and accordingly form the incisions 120′, 220′.

To guarantee that the profiles 110, 210 are definitely opposite the corresponding parts 411c and 412c of the knurl 400c, the tool can also include guide means of the profiles 110, 210, adapted to guide the profiles 110, 210 between the support roller 420 and the notched knurl or notched knurls 400c. For example, the guide means of the profiles 110, 210 can include a guide arranged upstream (in the direction of scrolling of the profiles 110, 210) of the roller 420 and the knurls 400c (guide via support web 100, 200 to be guided), including an arm presenting, at the level of a free end, a U-shaped housing. The housing is configured to receive and position the profiles 110, 210 of the web 100, 200 relative to the support roller 420 and the knurls 400c. For this, the lateral walls of the housing can for example be separated by a distance corresponding substantially to the distance between both end profiles 110, 210 of the webs 100, 200. As an alternative, the guide can include two arms extending on either side of the corresponding profiles 110, 210 of the web 100, 200 so a to apply lateral stress to both end profiles 110, 210 of the web 100, 200 to then guide them towards the knurls 400c and the support roller 420.

FIGS. 9f and 9g illustrate another embodiment, at the same time produce the preferred sound and tactile effect and guarantee sealing of the closure device.

For this, the closure device includes at least two complementary profiles 110a-110e, 210a-210e, preferably at least three, for example five complementary profiles 110a-110e, 210a-210e, as illustrated in FIGS. 9h and 9i.

In the embodiments illustrated, the complementary profiles 110a-110e, 210a-210e are borne by webs 100, 200 forming a single piece, located respectively on either side of the profiles 110a-110e, 210a-210e, each preferably having a width greater than the complementary profiles 110a-110e, 210a-210e. Also, the thickness of the webs 100, 200 opposite the profiles 110a-110e, 210a-210e is greater than the thickness of the web on the exterior of the profiles 110a-110e, 210a-210e, for example twice as big. Finally, the webs 100, 200 can be fitted with grooves 102, 202 on their surface for easier handling of the closure device.

The complementary profiles 110a-110e, 210a-210e are preferably of male/male type, and each include a rod 112, 214 overall perpendicular to the support web 100, 200 and fitted at its top opposite the support web 100, 200 with a widened protrusion 114, 216 in the form of an arrow head. The widened protrusions 114, 216 in fact form undercuts for reinforcing mutual hooking of the profiles 110, 210.

Within the scope of this embodiment, part of the complementary profiles 110a-110e, 210a-210e is altered sequentially in a direction perpendicular to the support webs 100, 200, the other part of the complementary profiles 110a-110e, 210a-210e remaining intact, that is, devoid of alterations such as defined in the invention.

Here too, the alterations 300 can especially include sequential crushings 120, 220 and/or sequential incisions 120′, 220′ without removal of material.

In this way, the complementary profiles 110a-110e, 210a-210e including alterations assure the tactile sensation and the sound effect of clicking during opening and closing of the closure device, whereas the complementary profiles devoid of these alterations assure sealing of the closure device.

For example, as illustrated in FIGS. 9h and 9i, each web 100, 200 of the closure device can include three complementary profiles 110a-110c, 210a-210c including alterations (here of squeezing 120, 220 type), and two complementary intact profiles 110d-110e, 210d-210e. As an alternative (not illustrated in the Figs.), for a closure device including five complementary profiles each web 100, 200 can include one, two or four complementary profiles 110a-110c, 210a-210c including alterations, and respectively four, three or one intact complementary profiles 110d-110e, 210d-210e. It is clear of course that this applies mutatis mutandis in the case of a closure device including different numbers of complementary profiles 110, 210.

In general, to combine the tactile and sound effects with the property of sealing, the webs 100, 200 must each preferably include at least one complementary profile including sequential alterations 300, and at least one complementary intact profile.

In use, to ensure the sealing of the closing of a bag fitted with a closure device according to the invention, the intact complementary profiles (that is, devoid of sequential alterations 300), can be placed randomly towards the base or towards the mouth of the bag, the sealing being guaranteed by the intact complementary profiles despite the very close presence of the sequential alterations 300 and any local deformations they can cause on the support webs 100, 200.

Also, the relative arrangement of the intact complementary profiles 110, 210 relative to the complementary profiles 110, 210 devoid of sequential alterations 300 has no effect on the tactile and sound sensation or on the capacity for sealing of the closure device. So, the profiles devoid of sequential alterations 300 and the intact profiles can be grouped randomly by type of profile (FIG. 9h), or alternate in the direction of width (FIG. 9i).

For example, FIG. 9h illustrates the case of a web 100 including three complementary closing profiles 110a-110c, including alterations of adjacent squeezing 120 type, extending parallel to two intact adjacent complementary profiles 110d-110e, and in FIG. 9i the case of a web 100 including the same complementary profiles 110a-110e arranged to alternate.

In this embodiment, the sequential alterations 300 can be made, whereas the complementary profiles 110a-110e, 210a-210e are separate, by means of the tool illustrated in FIG. 8c fitted this time with a notched knurl 400d with peripheral protrusions 410d adapted to the pitch and preferred sequential alterations 300, and of the support roller 420 located on opposite the side.

As evident in FIGS. 9f and 9g, the peripheral protrusions 410d of the knurl 400d present per se a first part 411d, dimensioned so as not to alter the profiles 110, 210, and a second part 412d, extending in the extension of the first part 411d, adapted to make the sequential alterations 300 preferred (sequential crushings 120, 220 or sequential incisions 120′, 220′) by locally altering the profiles 110, 210 according to their width.

For this, the second part 412d of the peripheral protrusions 410d present a larger diameter than the first part 411d of said protrusions 410d. Also, the height and the point of the second part 411d of the peripheral protrusions 410d is dimensioned so as to squeeze or cut the complementary profiles 110, 120 only, according to the type of preferred alteration 300, and this without altering the corresponding support web 100, 200.

To ensure that the profiles 110a-110e, 210a-210e are definitely opposite the parts 411d and 412d of the knurl 400d, to alter only the corresponding profiles 110d-110e, 210d-210e the tool can be fitted with guide means of the profiles, and especially of the guide, for taking up and positioning the profiles 110a-110e, 210a-210e relative to the support roller 420 and the knurls 400d.

The closure devices in keeping with the present invention can be made based on any suitable material, preferably based on polyolefin. Especially, to accentuate the substantial sound and tactile effects, the closing profiles 110, 210 can be made of relatively rigid plastic material, for example polypropylene. In this way, the succession of strong and weak points in engagement and separation of the profiles causes snapping to produce the preferred effects.

According to an embodiment, the closure device can include complementary profiles 110, 210 made of different materials. In fact, the contacting and separation of the complementary profiles 110, 210 made of rigid material can prove difficult, in particular when the profiles are all of male/male type, the tearing force in fact being very considerable. So, when the closure device includes at least two complementary profiles 110, 210, one of the profiles can be made of rigid material, whereas the other of the profiles can be made of a more flexible material.

For example, rigid materials to be used include high-density polypropylene or polyethylene, whereas flexible materials to be used include low-density polyethylene or polyethylene type.

The use of complementary bi-material profiles 110, 210, that is, made of different materials, especially has an advantage in the case of closure devices having sealing properties. The complementary profiles including alterations (profiles 110a-110c in FIGS. 9h and 9i) can in fact be made of rigid material to improve the sound and tactile effects of the device, whereas the intact complementary profiles (profiles 110d-110e on these same Figs.) can be made of a suppler material for easier engagement and separation in the longitudinal direction of the closure device. The use of suppler material also has the advantage of improving the sealing properties of the complementary profiles 110d-110e and therefore of the closure device, to the extent where these complementary profiles have better deformation capacity for limiting the risks of accidental opening under the effect of internal pressure of the bags.

The bi-material complementary profiles 110, 210 can be co-extruded directly with the support webs 100, 200 (the profiles 110, 210 being made of the same material as the corresponding segment of the web 100, 200 on which they are attached), or obtained separately and then attached to the latter, conventionally.

Nevertheless, according to the materials selected for the different complementary profiles 110, 210, problems of cohesion between the materials constituting the complementary profiles 110, 210, and where appropriate the support webs 100, 200, can appear.

In this case, it is possible especially to fit each complementary profile with a tread 116 extending according to the longitudinal direction of the profiles 110, 210, and to fix this tread 116 on the corresponding web 100, 200. The tread 116 is preferably formed integrally with the respective rod 112, 214 of the profiles 110, 210, and can extend for example either side of the rod 112, 214, over a width at least equal to the width of the widened protrusion 114, 216 of the profiles 112, 214.

The tread 116 can be attached by means of a conventional binder 118, applied between the corresponding web 100, 200 and the tread 116 over its entire length, as illustrated in FIG. 23a. As an alternative, the tread 116 can be embedded in the material of the support web 100, 200, as illustrated in FIG. 23b. Reference could especially be made to French application FR 2 884 119 for more details on the profiles fitted with treads 116.

If needed, when the webs 100, 200 include several complementary profiles 110, 210 made of different materials, each complementary profile 110, 210 can be fitted with its own tread 116. As an alternative, a simple tread can be made per group of complementary profiles 110, 210 made of the same material. Therefore, in the example of a device with five profiles 110, 210 described hereinaforementioned, the complementary profiles 110a-110c, 210a-210c made of rigid material can be formed integrally with a common tread or each be formed integrally with their own tread, then attached on the complementary web 100, 200. The closing profiles 110d-100e as such, made of suppler material, can form a single piece with the web complementary 100, 200 or, as an alternative, also be fitted with such a tread and attached on the corresponding web 100, 200, similarly to the profiles 110a-110c, 210a-210c made of rigid material.

One skilled in the art will understand that making alterations of both complementary profiles 110, 210, reinforces the tactile sensation and the sound effect of clicking obtained especially during opening of the device, but also during its closing, due to the succession of strong points and weak points in the engagement and the separation as defined in the longitudinal direction of closing.

The present invention in fact produces considerable sequential alteration of both complementary profiles 110, 210, and ensures their possible engagement and separation. In fact, in the case of crushings 120, 220, the latter are perfectly complementary, as they are borne out in a closed position of both profiles 110, 120, whereas in the case of sequential incisions 120′, 220′, the profiles 110, 120 are not deformed according to their width such that they remain complementary despite any shift of the incisions 120′, 220′ between the complementary profiles 110, 120.

It is evident that the presence of segments 130, 230 of constant segment and therefore easy engagement of these segments between two alterations 300 by simple sliding between the fingers of a user prolongs the engagement obtained at the level of such segments 130, 230 of constant segment towards the deformed alteration areas 300.

Reinforcement of the tactile sensation and sound effect as a result of the present invention results from common enlarging achieved on both profiles.

By way of non-limiting example, the pitch of the sequential alterations is comprised between 4 mm and 1 cm.

Also within the scope of the present invention, the crushings are preferably achieved such that the result is flaring in the direction of the width L of the profiles 110, 120, at least equal to 5% of the original width L, preferably greater than 10% of this width L.

The squeezing and/or incision knurls 400a-400d and if needed the support roller 420 can be heated to reinforce the alteration of closing profiles 110, 210 and ensure that the latter is kept in position.

However, if the material allows, the crushings can be achieved by means of simple knurls 400a-400d at room temperature.

According to yet another alternative, the sequential alterations can be achieved with knurls 400a-400d at room temperature, but operating on “softened” closing, that is, deformed by hot extrusion at the output of the latter.

FIG. 10 illustrates a bag according to the present invention. FIG. 10 shows a series of alterations distributed over the length of the closure device.

Naturally the present invention is not limited to the particular embodiments which have just been described, but extends to any alternative according to its nature. In particular, FIGS. 11 to 22 illustrate embodiments wherein the alterations 300 include sequential crushings 120, 220, achieved on closure devices including two complementary profiles 110a/210a and 110b/210b per web 100, 200. But this is not limiting, to the extent where one skilled in the art can apply the invention as described without difficulty for sequential alterations 300 including incisions 120′, 220′ combined or not with crushings 120′, 220 and/or intact profiles, if needed on webs including a larger number of complementary profiles 110, 210 and with different types of profiles (male/male, hooks, etc.).

As illustrated in FIGS. 11 to 22, according to alternative embodiments in line with the present invention, the closure device can include at least two pairs of parallel complementary profiles. This arrangement reinforces especially sealing of the bags once closed and limits the risks of accidental opening under the effect of internal pressure of the bags.

In this case it can be provided that both pairs of parallel profiles are simultaneously squeezed sequentially with the same pitch and synchronised, as illustrated in FIGS. 14 to 16, or with longitudinal shift, as illustrated in FIGS. 17 to 19 (or again encore with different pitches or in multiples from one pair of profiles to the other, with or without longitudinal shift) or just one pair of profiles is squeezed, as illustrated in FIGS. 11 to 13.

As illustrated in FIGS. 20 to 22 where appropriate one at least of the pairs of profiles can be formed from complementary profiles in a hook 150, 160.

FIGS. 11, 12 and 13 illustrate a first alternative embodiment of a closure device according to the present invention including two pairs of parallel complementary closing profiles 110a/210a and 110b/210b. More precisely, FIGS. 11, 12 and 13 illustrate respectively a view in partial perspective of the closure device after sequential alteration by squeezing of a pair of profiles 110a/210a (the second pair of profiles 110b/210b is not squeezed) and individual views of male profiles 110a and 110b and female profiles 210a and 210b forming in combination a closure device according to the present invention illustrated in FIG. 11.

FIGS. 14, 15 and 16 illustrate a second alternative embodiment of a closure device according to the present invention including two pairs of parallel complementary closing profiles 110a/210a and 110b/210b. More precisely, FIGS. 14, 15 and 16 illustrate respectively a view in partial perspective of the closure device after sequential alteration by squeezing of two pairs of profiles 110a/210a and 110b/210b and individual views of male profiles 110a and 110b female and profiles 210a/210b forming in combination a closure device according to the present invention illustrated in FIG. 14.

FIGS. 17, 18 and 19 illustrate a third alternative embodiment of a closure device according to the present invention including two pairs of parallel complementary closing profiles 110a/210a and 110b/210b. More precisely, FIGS. 17, 18 and 19 illustrate respectively a view in partial perspective of the closure device after sequential alteration by squeezing of two pairs of profiles 110a/210a and 110b/210b with longitudinal shift between the crushings achieved on both pairs of profiles and individual views of male profiles 110a and 110b and female profiles 210a and 210b forming in combination a closure device according to the present invention illustrated in FIG. 17.

FIGS. 20, 21 and 22 illustrate a fourth alternative embodiment of a closure device according to the present invention including two pairs of parallel complementary closing profiles complementary of male/female type 110/210 and the other of complementary hook type 150/160. More precisely, FIGS. 20, 21 and 22 illustrate respectively a view in partial perspective of the closure device after sequential alteration by squeezing and individual views of profiles borne by opposite supporting films and forming in combination a closure device according to the present invention illustrated in FIG. 20.

1. A closure device for bags or the like comprising complementary profiles borne by respective support webs, wherein each support web comprises at least two complementary profiles forming a multiple closing, wherein each complementary profile extends along a first direction and has a width which extends transversally to said first direction, wherein the multiple closing comprises:
complementary profiles having sequential crushings of the two engaged profiles along a second direction which is perpendicular to the first direction, wherein the width of the two complementary profiles flares at the level of said sequential crushings along a third direction which is transverse to the first direction and to the second direction, and
complementary profiles comprising sequential incisions without removal of material along the second direction.

2. The device according to claim 1, comprising at least five complementary profiles, wherein at least three complementary profiles comprise sequential crushings.

3. The device according to claim 2, comprising at least one complementary profile is devoid of sequential alterations.

4. The device according to claim 1, wherein the complementary profiles include profiles of male/male type.

5. The device according to claim 1, wherein at least one part of the complementary profiles is made of a first material, and at least one other part of the complementary profiles is made of a second material, different to the first material.

6. The device according to claim 5, wherein the first material includes polypropylene or high-density polyethylene, and the second material includes polyethylene or low-density polyethylene.

7. The device according to claim 6, wherein the complementary profiles including sequential alterations are made of the first material.

8. The device according to of claim 6, wherein the complementary profiles made of the first material and/or the complementary profiles made of the second material are formed integrally with a tread, attached on the corresponding web.

9. The device according to claim 8, wherein the tread is attached on the corresponding web by means of a binder.

10. The device according to claim 9, wherein the tread is embedded in the corresponding web such that said tread is attached on said web.

11. The device according to claim 1, characterised in that the pitch of the sequential crushings is comprised between 4 mm and 1 cm.

12. A closure device for bags or the like comprising complementary profiles borne by respective support webs, wherein each support web comprises at least two complementary profiles forming a multiple closing, wherein each complementary profile extends along a first direction and has a width which extends transversally to said first direction, wherein the multiple closing comprises:
complementary profiles having sequential crushings of the two engaged profiles along a second direction which is perpendicular to the first direction, wherein the width of the two complementary profiles flares at the level of said sequential crushings along a third direction which is transverse to the first direction and to the second direction, and
complementary profiles devoid of sequential alterations.

13. The device according to claim 12, comprising at least five complementary profiles, wherein at least three complementary profiles comprise sequential crushings.

14. The device according to claim 13, wherein at least one complementary profile comprises sequential incisions.

15. The device according to claim 12, wherein the complementary profiles include profiles of male/male type.

16. The device according to claim 12, wherein at least one part of the complementary profiles is made of a first material, and at least one other part of the complementary profiles is made of a second material, different to the first material.

17. The device according to claim 16, wherein the first material includes polypropylene or high-density polyethylene, and the second material includes polyethylene or low-density polyethylene.

18. The device according to claim 17, wherein the complementary profiles including sequential alterations are made of the first material.

19. The device according to claim 17, wherein the complementary profiles devoid of sequential alterations are made of the second material.

20. The device according to claim 17, wherein the complementary profiles made of the first material and/or the complementary profiles made of the second material are formed integrally with a tread, attached on the corresponding web.

21. The device according to claim 20, wherein the tread is attached on the corresponding web by means of a binder.

22. The device according to claim 21, wherein the tread is embedded in the corresponding web such that said tread is attached on said web.

23. The device according to claim 12, wherein the pitch of the sequential crushings is comprised between 4 mm and 1 cm.

24. A bag, characterised in that it includes a closure device according to claim 1.
